(19) United States
(12) Patent Application Publication
(10) Pub. No.: US 2023/0019547 A1
(43) Pub. Date: Jan. 19, 2023

(54) UPLINK DATA TRANSMISSION SCHEDULING

(71) Applicant: ZEKU, INC., Palo Alto, CA (US)

(72) Inventors: Su-Lin LOW, San Diego, CA (US); Tianan Tim MA, San Diego, CA (US); Hausting HONG, San Diego, CA (US)

(21) Appl. No.: 17/870,688

(22) Filed: Jul. 21, 2022

Related U.S. Application Data
(63) Continuation of application No. PCT/IB2020/058407, filed on Sep. 10, 2020.
(60) Provisional application No. 62/964,059, filed on Jan. 21, 2020.

(51) Int. Cl. H04W 72/12; H04W 72/14; H04L 1/00

(52) U.S. Cl. CPC H04W 72/1268; H04W 72/1242; H04W 72/14; H04L 1/0007

(57) ABSTRACT

An apparatus and method for uplink data transmission scheduling are disclosed. In an example, the method can include obtaining, by at least one processor, a plurality of packets to be transmitted via uplink. The method can also include queueing, by the at least one processor, the plurality of packets according to logical channel prioritization. The method can further include receiving, by the at least one processor, a service grant after the queueing. The method can additionally include trimming, by the at least one processor, the plurality of packets according to a grant size of the service grant.

### CROSS-REFERENCE TO RELATED APPLICATION

This is a continuation application of International Application No. PCT/IB2020/058407, filed Sep. 10, 2020, which claims the benefit of priority to U.S. Provisional Application No. 62/964,059 filed Jan. 21, 2020, entitled “EFFICIENT 5G UPLINK MAC DATA TRANSMISSION SCHEDULING METHOD FOR HIGH THROUGHPUT AND LOW LATENCY PACKETS,” the contents of which are hereby incorporated by reference in their entireties.

### BACKGROUND

Embodiments of the present disclosure relate to apparatus and methods that may be used to communicate data according to a schedule.

Wireless communication systems are widely deployed to provide various telecommunication services such as telephony, video, data, messaging, and broadcasts. Various wireless communication systems rely on scheduled communication of data. For example, in a fifth generation (5G) communication system, an access node may schedule transmission by one or more user equipment devices. The user equipment devices may be responsible for communicating data according to the schedule.

### SUMMARY

Embodiments of methods and apparatus that may be used to communicate data according to a schedule are disclosed herein.

In one example, an apparatus can include at least one processor and at least one memory including computer program code. The at least one memory and the computer program code can be configured to, with the at least one processor, cause the apparatus at least to obtain a plurality of packets to be transmitted via uplink. The at least one memory and the computer program code can also be configured to, with the at least one processor, cause the apparatus at least to queue the plurality of packets according to logical channel prioritization. The at least one memory and the computer program code can further be configured to, with the at least one processor, cause the apparatus at least to receive a service grant after the queueing. The at least one memory and the computer program code can additionally be configured to, with the at least one processor, cause the apparatus at least to trim the plurality of packets according to a grant size of the service grant.

In another example, a method for data transmission scheduling can include obtaining, by at least one processor, a plurality of packets to be transmitted via uplink. The method can also include queueing, by the at least one processor, the plurality of packets according to logical channel prioritization. The method can further include receiving, by the at least one processor, a service grant after the queueing. The method can additionally include trimming, by the at least one processor, the plurality of packets according to a grant size of the service grant.

In still another example, a non-transitory computer-readable medium can be encoded with instructions that, when executed at least one processor, perform a process. The process can include obtaining a plurality of packets to be transmitted via uplink. The process can also include queueing the plurality of packets according to logical channel prioritization. The process can further include receiving a service grant after the queueing. The process can additionally include trimming the plurality of packets according to a grant size of the service grant.

In yet another example, an apparatus can include a packet obtaining module configured to obtain a plurality of packets to be transmitted via uplink. The apparatus can also include a packet queueing module configured to queue the plurality of packets according to logical channel prioritization. The apparatus can further include a grant serving module configured to receive a service grant after the queueing. The apparatus can additionally include a packet trimming module configured to trim the plurality of packets according to a grant size of the received service grant.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a modem data processing stack.

FIG. 2 illustrates an exemplary wireless network according to certain embodiments of the present disclosure.

FIG. 3 illustrates an exemplary method for data transmission scheduling according to certain embodiments of the present disclosure.

FIG. 4 illustrates further details of the method shown in FIG. 3 according to certain embodiments of the present disclosure.

FIG. 5 illustrates additional details of the method shown in FIG. 3 according to certain embodiments of the present disclosure.

FIG. 6 illustrates the preparation of packets in relation to a service grant according to certain embodiments of the present disclosure.

FIG. 7 illustrates a timing diagram in relation to the method shown in FIG. 3 according to certain embodiments of the present disclosure.

FIG. 8 illustrates another exemplary method for data transmission scheduling according to certain embodiments.

FIG. 9 illustrates further details of the method shown in FIG. 8 according to certain embodiments of the present disclosure.

FIG. 10 illustrates further details of the method shown in FIG. 8 according to certain embodiments of the present disclosure.

FIG. 11 illustrates a block diagram of an exemplary node according to certain embodiments of the present disclosure.

FIG. 12 illustrates a block diagram of an exemplary system for data transmission scheduling according to certain embodiments of the present disclosure.

FIG. 13 illustrates a block diagram of an exemplary packet queueing module of the system shown in FIG. 12 according to certain embodiments of the present disclosure.

FIG. 14 illustrates a block diagram of an exemplary grant serving module of the system shown in FIG. 12 according to certain embodiments of the present disclosure.

Embodiments of the present disclosure will be described with reference to the accompanying drawings.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of a person skilled in the pertinent art to effect such feature, structure or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The techniques described herein may be used for various wireless communication networks such as Long Term Evolution (LTE) system, code division multiple access (CDMA) system, time division multiple access (TDMA) system, frequency division multiple access (FDMA) system, orthogonal frequency division multiple access (OFDMA) system, single-carrier frequency division multiple access (SC-FDMA) system, and other networks. The terms “network” and “system” are often used interchangeably. A CDMA network may implement a radio technology such as Universal Terrestrial Radio Access (UTRA), CDMA 2000, etc. UTRA includes Wideband CDMA (WCDMA) and other variants of CDMA. CDMA 2000 covers IS-2000, IS-95, and IS-856 standards. A TDMA network may implement a radio technology such as Global System for Mobile Communications (GSM). An OFDMA network may implement a radio technology such as new radio (NR) (e.g., 5G RAT), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). NR is an emerging wireless communications technology under development in conjunction with the 5G Technology Forum (SGTF). 3GPP Long Term Evolution (LTE) and LTE-Advanced (LTE-A) are releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies.

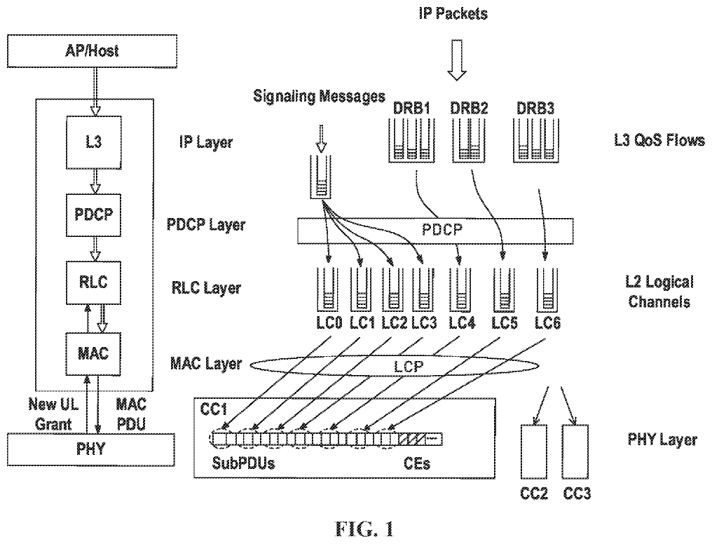

FIG. 1 illustrates a modem data processing stack. As shown in FIG. 1, in a 5G cellular wireless modem, the packet data protocol stack includes the Internet protocol (IP) layer (also known as Layer 3 (L3)), the packet data convergence protocol (PDCP) layer, the radio link control (RLC) layer, and the media access control (MAC) layer. Each layer is responsible for processing the user plane packet data in the form of IP data or raw user data and ensuring that data transmission is secure, on-time, and error-free.

In the uplink (UL) direction, incoming packet data from an external application processor (AP) or a host (e.g., through universal serial bus (USB) or peripheral component interconnected express (PCIe)) in the form of IP packets from a protocol data unit (PDU) session arrives at the Layer 3 protocol stack. These IP packets are classified into the quality of service (QoS) flows in each data radio bearer (DRB), shown as DRB1, DRB2, and DRB3. Packets in each DRB will be dequeued and processed by the packet data convergence protocol (PDCP) layer. PDCP layer processing includes robust header compression (ROHC) and security functions, such as integrity checking and ciphering. Once the PDCP layer processing is done, the packets are queued into its corresponding Layer 2 (L2) logical channels (LCs), identified as LC0, LC1, LC2, LC3, LC4, LC5, and LC6. In the meantime, modem signaling messages also arrive at their Layer 2 logical channels for signaling messages.

At the physical (PHY) layer, at every slot, the physical downlink control channel (PDCCH), which contains the downlink control indicator (DCI) information, is decoded. The DCI contains the dynamic grant allocation for dynamic uplink transmission, for a slot transmission at an indicated time. The transmission time offset (K2) may be expressed in terms of slots, or for 5G low latency application, K2 may be in symbols and may indicate that the transmission needs to be done in the same slot.

At the MAC layer, once the dynamic grant allocation size is calculated, the modem has to dequeue and gather L2 packets from the logical channels through a logical channel prioritization (LCP) algorithm as specified in the 3GPP standard and compose the MAC protocol data unit (PDU) in a transport block for the PHY layer to be sent out. There is one such transport block for each component carrier. Hence packet data is being transmitted out from the packet data stack to the base station (BS) according to the logical channel prioritization in the base station-allocated uplink grant size for each slot.

MAC sub-PDU (MacSubPDU) packets can be prepared in L2 logical channel queues after L3 data arrives at the modem. Once a dynamic grant is allocated by a base station and received by the MAC layer, the MAC layer can perform logical channel prioritization to create a MAC PDU with the exact grant size. The packets in the logical channels are extracted with priority accordingly from the logical channel prioritization. After that, the MAC PDU is transferred to the physical layer for transmission.

In another approach, logical channel L2 data within each individual logical channel queue are combined a few packets at a time to a continuous block. However, they are not prepared in a MAC PDU format, because the exact grant allocation size is still not known yet. Once a dynamic grant is allocated by the base station and received by the MAC layer, the MAC layer performs the logical channel prioritization to create the MAC PDU with the exact grant size. The packets in the logical channels are extracted with priority accordingly from the logical channel prioritization. After that, the MAC PDU is transferred to the physical layer for transmission. The assembly of a first transport block corresponding to a component carrier (CC) is shown for CC1, but a similar assembly may occur for each of CC2 and CC3 and so on, as well.

One challenge in MAC transmission is how to gather the MacSubPDU or L2 packets in the MAC PDU in the limited time given, from the time when the exact dynamic grant allocation size is received in the current slot to the transmission time. The transmission time offset can be referred to as K2. If the transmission time offset (K2) from current slot n means that transmission will occur two or more time slots later (i.e., slot n+2 or later), the uplink MAC will have a longer time to prepare the MAC PDU for the scheduled slot transmission. However, if the K2 requires that the transmission is in the next slot (i.e., slot n+1) or the same slot (i.e., slot n), then there may be insufficient time to dequeue with priority, gather the MacSubPDUs with exact grant size, and prepare the MAC PDU for transmission encoding.

Since, in certain approaches, the logical channel prioritization is performed only after the exact dynamic grant size is known, it may take a long time to gather the packets from various memory locations from the several logical channel queues, and construct the MAC PDU for physical layer transmission. This time may exceed the K2 interval given before the scheduled transmission time, which may cause a transmission error.

Certain embodiments of the present disclosure can avoid frequent transmission errors due to preparation time exceeding the transmission time offset interval. Furthermore, certain embodiments of the present disclosure can avoid excessive delay in forming MAC PDUs from Layer 2 to the MAC layer to the physical layer. Certain embodiments of the present disclosure can also minimize memory storage needed for L2 packet queues. Furthermore, certain embodiments of the present disclosure can provide efficient data movement among L3, L2, MAC, and physical layers. Additionally, certain embodiments of the present disclosure can reduce power expenditure due to reduced memory storage and decreased data movement.

Certain embodiments of the present disclosure relate to a system configured to prepare at least one MAC PDU as much ahead of time as possible. For example, certain embodiments relate to a system that prepares the MAC PDU before a grant indication from a base station arrives with a dynamically allocated grant size. The grant indication may dictate that the user equipment transmits within a very short time following the receipt of this grant.

Certain embodiments of the present disclosure provide an efficient method for scheduling 5G uplink MAC packets for data transmission. Certain embodiments of the present disclosure can allow effective execution of packet preparation before the transmission deadline, which is suitable for high throughput and low latency packets.

According to one aspect, certain embodiments of the present disclosure prepare MAC PDUs ahead of time. For example, the user equipment or other terminal device may prepare one or many MAC PDUs with logical channel prioritization before receiving a grant indication from a base station or other access node. The grant indication from the access node may have a dynamically allocated grant size. The grant indication may also instruct the terminal device to transmit within a very short time following receipt of the grant. A very short time may be in the same slot or next slot.

According to another aspect, certain embodiments of the present disclosure relate to trimming a prepared MAC PDU packet list response to a service grant. A service grant, also referred to as an uplink grant or servicing grant, can be transmitted by an access node to a user equipment, for example, in downlink control information (DCI). A given DCI scheduling message may provide information for scheduling one or more user equipment. Various DCI message formats may be used, and these formats may depend on, for example, what channel is being allocated, the type of operation being scheduled, the type of transmission being scheduled, and so on. The 3GPP provides some standardization of DCI, but service grants that comply with other standards and no standard are also permitted. The service grant can include an indicator of when transmission for the user equipment is scheduled, which can be expressed by a value K2, which can be an integer, for example, from zero to thirty-two. In certain cases, the value of zero can be implied by not explicitly indicating a K2 value.

By preparing the MAC PDUs according to logical channel prioritization of upper layer packets early enough, and then at the servicing grant time, trimming the prepared MAC PDU packet list to fit into the exact received grant size for transmission at a slot (e.g., n+K2), the packets can be retrieved and encoded for transmission at the scheduled time efficiently.

According to still another aspect, certain embodiments of the present disclosure provide the assembly of prepared L2 MacSubPDU packets into a contiguous memory block. In the MAC PDU preparation with logical channel prioritization, the L2 MacSubPDU packets may be assembled into a contiguous memory block after PDCP layer processing, allowing efficient data transfer streaming to the physical layer.

According to yet another aspect, certain embodiments of the present disclosure provide a fast transmission (FastTx) queue for low latency packets. A FastTx queue may be maintained to allow high priority and/or low latency packets to be served first when scheduling the MAC PDU for the next upcoming transmission.

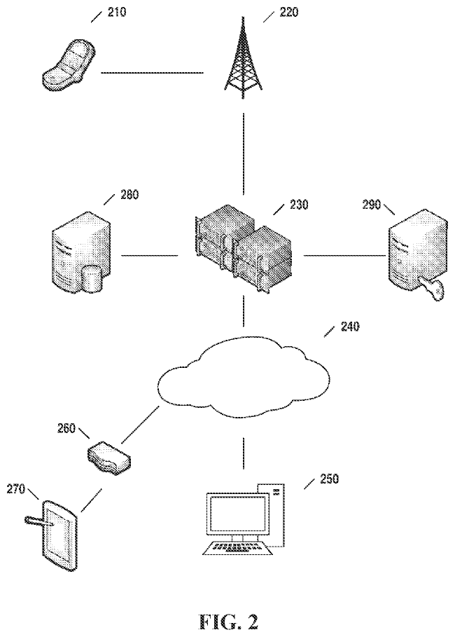

FIG. 2 illustrates an exemplary wireless network 200, such as an NR or 5G network, in which aspects of the present disclosure may be performed, for example, for enabling uplink data transmission scheduling, as described in greater detail below. As shown in FIG. 2, wireless network 200 may include a network of nodes, such as a user equipment 210, an access node 220, and a core network element 230. User equipment 210 may be any terminal device, such as a smart phone, personal computer, laptop computer, tablet computer, vehicle computer, wearable electronic device, smart sensor, or any other device capable of receiving, processing, and transmitting information, such as any member of a vehicle to everything (V2X) network, a cluster network, a smart grid node, or an Internet-of-Things (IoT) node. Other devices are also permitted. User equipment 210 is illustrated as a smart phone simply by way of illustration and not by way of limitation.

An access node 220 may be a device that communicates with the user equipment 210, such as wireless access point, a base station, an enhanced Node B (eNB), a cluster master node, or the like. Access node 220 may have a wired connection to user equipment 210, a wireless connection to user equipment 210, or any combination thereof. Access node 220 may be connected to user equipment 210 by multiple connections, and user equipment 210 may be connected to other access nodes in addition to access node 220. Access node 220 may also be connected to other user equipment. Access node 220 is illustrated by a radio tower by way of illustration and not by way of limitation.

A core network element 230 may serve access node 220 and user equipment 210 to provide core network services. Examples of a core network element 230 include a home subscriber server (HSS), a mobility management entity (MME), a serving gateway (GW), a packet data network (PDN) GW. These are examples of core network elements of an evolved packet core (EPC) system, which is a core network for the LTE system. Other core network elements may be used in LTE and in other communication systems. Core network element 230 is shown as a set of rack-mounted servers by way of illustration and not by way of limitation.

Core network element 230 may connect with a large network, such as the Internet 240, or another IP network, to communicate packet data over any distance. In this way, data from user equipment 210 may be communicated to other user equipment connected to other access points, including, for example, a personal computer 250 connected to Internet 240, for example, using a wired connection, or a tablet 270 connected to Internet 240 via a router 260. Thus, personal computer 250 and tablet 270 provide additional examples of possible user equipment devices, and router 260 provides an example of another access point device.

A generic example of a rack-mounted server is provided as an illustration of core network element 230. However, there may be multiple elements in the core network including database servers, such as database 280, and security and authentication servers, such as authentication server 290. Database 280 may, for example, manage data related to user subscription to network services. A home location register (HLR) is an example of standardized database of subscriber information for a mobile network. Likewise, authentication server 290 may handle authentication of users, sessions, and so on. In 5G, an authentication server function (AUSF) may be the specific entity to perform user equipment authentication. In certain embodiments, a single server rack may handle multiple such functions, such that the connections between core network element 230, authentication server 290, and database 280 may be local connections within a single rack.

Certain embodiments of the present disclosure may be implemented in a modem of a user equipment, such as user equipment 210, tablet 270, or personal computer 250. For example, a modem or other transceiver of user equipment 210 may be scheduled for transmission by a communication from access node 220. As described below in detail, user equipment 210 may prepare in advance of receiving a service grant that schedules transmission and then may finalize one or more MAC PDU based on the service grant.

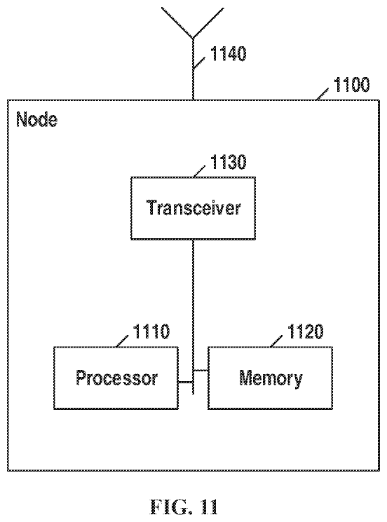

Each of the elements of FIG. 2 may be considered a node of a communication network. More detail regarding the possible implementation of communication nodes is provided by way of example in the description of FIG. 11 and node 1100 below. For example, user equipment 210 in FIG. 2 may be implemented as node 1100 shown in FIG. 11.

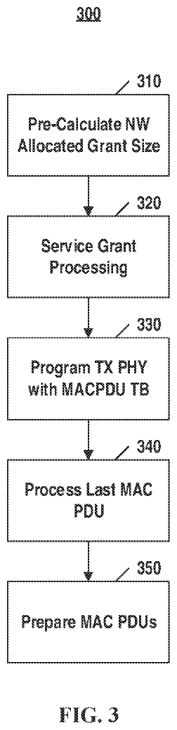

FIG. 3 illustrates an exemplary method 300 for data transmission scheduling according to certain embodiments of the present disclosure. It is understood that the operations shown in method 300 are not exhaustive and that other operations can be performed as well before, after, or between any of the illustrated operations. Further, some of the operations may be performed simultaneously, or in a different order than shown in FIG. 3. As shown in FIG. 3, every slot, upon the receipt of PDCCH DCI information after PDCCH decoding, if the transmission time offset (K2) from current slot n is equal or less than one slot, the uplink MAC in the modem can perform the following procedures. As mentioned above, the modem can be provided in a user equipment. The modem can include any suitable transceiver, processor, and memory 1120, such as transceiver 1130, processor 1110, and memory 1120 in FIG. 11.

As shown in FIG. 3, starting at operation 310, the modem can calculate network (NW) allocated grant size. At every slot, the modem can decode the PDCCH, which carries the DCI information. Here the grant size allocated by the access node, e.g., a base station, is calculated from the received time and resource allocation information. The physical layer of the modem can send a slot uplink grant indicator (Slot UL Grant Ind) with the grant size, and the transmission time offset (K2) to the MAC layer.

At operation 320, the modem can process a service grant. Specifically, the modem can process a grant received from the physical layer for the next or current slot, either with respect to new or retransmission data. For new data, the modem can compose the MAC PDU with the actual grant size received for the slot. Data for the slot can be retrieved from MAC queues containing prepared MAC PDUs, and re-prepared (for example, trimmed or filled out) MAC PDUs to fulfill the exact grant received from the network. For retransmission data, the modem can prepare the retransmission data by retrieving the sent data from a hybrid automatic repeat request (HARD) queue. To illustrate further, the grant service for new data can be as follows. The goal may be to assemble the MAC PDU for physical layer transmission in the fastest possible time. When the MAC PDU packet list was prepared earlier in contiguous memory, a trimming step can be executed quickly to trim the prepared packet list to the exact grant size allocated by the network.

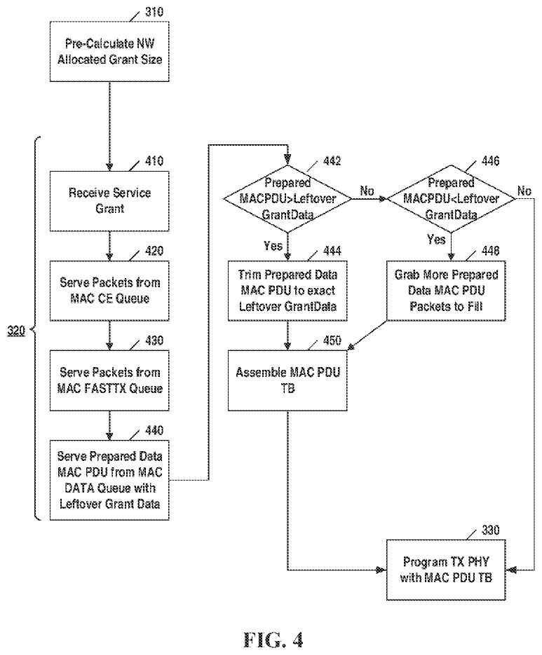

FIG. 4 illustrates further details of method 300 shown in FIG. 3 according to certain embodiments of the present disclosure. For example, FIG. 4 illustrates more details regarding operation 320 in FIG. 3. As shown in FIG. 4, the modem can, at operation 410, receive a service grant for the next or same slot.

At operation 420, the modem can serve packets from a MAC control element queue (MACCEQ). The MAC control element may be the highest priority packets that need to be included in the MAC PDU creation. These requests may be queued in the MACCEQ, which may be a separate queue from the other queues. These requests may be served according to their priorities. The MAC CE packets are attached to the ends of the MAC PDU packets. The grant bytes are subtracted with the length of these MAC CE packets first.

At operation 430, the modem may serve packets from a MAC fast transmission queue (MACFASTTXQ). The low latency, high priority packets from various logical channels can be grouped together and fast-tracked through a separate special MACFASTTXQ earlier. At this stage of MAC PDU assembly, these packets are served first into the MAC PDU. The current grant bytes are then subtracted with the length of these MAC CE packets first.

At operation 440, the modem can serve prepared data MAC PDU from a MAC data queue (MACDATAQ) with leftover grant data (GrantData). For the remaining grant data bytes, the prepared MAC PDUs from the MACDATAQ can be served. Since these MAC PDUs were prepared with an estimated grant size, they may need to be trimmed to the exact leftover grant data bytes.

At operation 442, the modem can determine whether the prepared MAC PDU is greater than the leftover grant data. If so, the prepared MAC PDU has exceeded the remaining grant data. Thus, in such a case, the modem can proceed to, at operation 444, trim the prepared data MAC PDU to the exact grant data. For example, the lower priority packet data bytes may be trimmed off to fit into the exact grant size remaining. The MAC PDU may have been prepared with logical channel prioritization (LCP), which dequeued with priority the packets from the logical channels when assembling the prepared MAC PDU. Thus, for example, the lower priority packet data bytes may be at the end of the prepared MAC PDU. During this trimming process, the last packet will be segmented to form two Radio Link Control (RLC) packets. The first segment will be served in this grant, and the second segment will be queued with high priority for the next grant transmission.

If the modem determines the prepared MAC PDU does not exceed the leftover grant data, the modem can, at operation 446, determine whether the opposite is true, namely, whether the prepared MAC PDU is less than the grant data. If not, this implies that no adjustment to the MAC PDU is needed. In certain cases, however, the modem may determine that the prepared MAC PDU has fewer bytes than the remaining grant data. In this case, the modem may, at 448, grab more prepared data MAC PDU packages to fill grant data. In such cases, the next prepared MAC PDU is retrieved, and the relevant bytes are extracted to fit in the current remaining grant.

At operation 450, upon either trimming at operation 444 or grabbing more data at operation 448, the modem can assemble a final MAC PDU transport block (TB). The MAC PDU can be assembled with the MAC PDU subblocks, where the fast transmission and data MAC PDU are already prepared in contiguous memory blocks.

At operation 330, upon the completion of grant service at operation 320, whether by using the previously prepared MAC PDU (in the case that the prepared MAC PDU exactly matches the service grant) or by using the MAC PDU transport block assembled at operation 450, the modem can program physical layer transmission with the MAC PDU transport block. More particularly, the MAC PDU transport block can be sent to the physical layer to be transmitted. The bytes may be encoded per the 3GPP standard (or any other desired standard) at the physical layer and sent out accordingly. Operation 330 shown in FIG. 4 can be the same as operation 330 shown in FIG. 3.

Referring back to FIG. 3, operation 340 can follow operation 330. At operation 340, the modem can process MAC PDU data sent in slot n−1, which can refer to the last sent MAC PDU. The last sent MAC PDU from slot n−1 can be moved from a MAC sent queue (MAC SENDQ) to a MAC hybrid automatic repeat request queue (MACHARQQ), so that any MAC PDU can be retransmitted later.

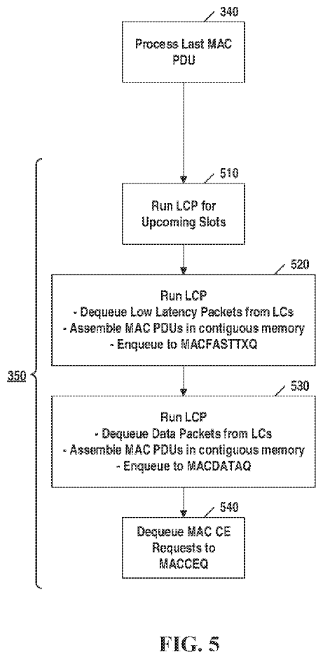

At operation 350, the modem can prepare MAC PDUs for upcoming slots. FIG. 5 illustrates additional details of method 300 shown in FIG. 3 according to certain embodiments of the present disclosure. For example, FIG. 5 illustrates additional details regarding operation 350.

As shown in FIG. 5, at operation 510, the modem can run logical channel prioritization (LCP) to prepare for upcoming slots. More particularly, at operation 520, the modem can run logical channel prioritization for low latency packets. In running logical channel prioritization for low latency packets at operation 520, the modem can use the MAC layer to dequeue low latency packets from corresponding logical channels and assemble a MAC PDU in contiguous memory. This MAC PDU can then be enqueued to the MACFASTTXQ to be fast-tracked. In the case where some high priority low latency packets arrived after a previous normal MAC PDU was already prepared in the MACDATAQ, these packets can be preferentially served instead of the prepared MAC PDU in the normal data MACDATAQ (which may contain multiple queued MAC PDUs).

Furthermore, the modem can run logical channel prioritization with respect to data packets at operation 530. The MAC layer of the modem can dequeue data packets from logical channels and can assemble MAC PDUs in contiguous memory. This MAC PDU can then be enqueued to MACDATAQ. Additionally, at operation 540, the modem can dequeue MAC control element requests to MACCEQ. In addition to data packets, MAC control element requests are also composed in contiguous memory and queued in a separate MACCEQ, to be assembled into the tail of the final service MAC PDU.

Although operations 520, 530, and 540 are shown in one order, they may be performed in parallel or in a different order than shown. For example, operations 520, 530, and 540 can be performed on packets that come to the modem for transmission, depending on the type of packet received at the modem. Thus, the various queues can be variously updated on an as-needed and nearly real-time basis.

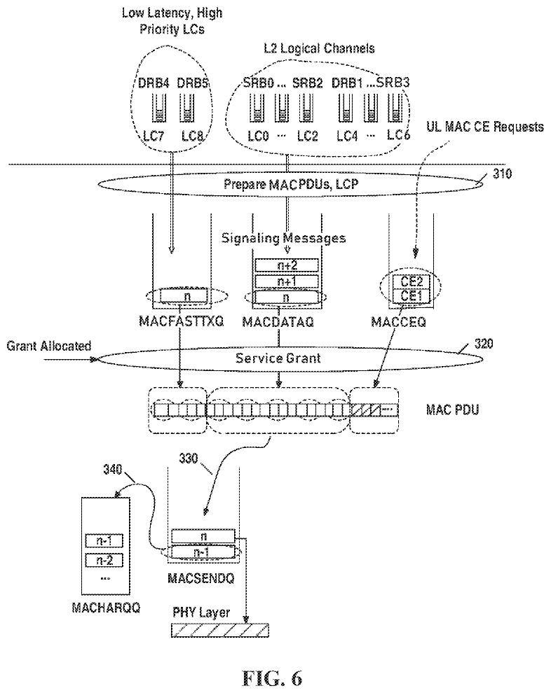

FIG. 6 illustrates the preparation of MAC PDU packets in relation to a service grant according to certain embodiments of the present disclosure. As shown in FIG. 6, n can refer to a current slot, n+1 can refer to a next slot, and n−1 can refer to a last slot, and so on. As described above, a value of zero for K2 may indicate that transmission should occur in the same slot as the service grant reception, namely slot n. Although the procedure shown in K2 is shown relevant to processing in the case where K2 is zero, a similar procedure can be applied in cases where K2 is one or more.

As shown in FIG. 6, there can be various sources of packets to be incorporated into the MAC PDU. A first preparation step corresponding to operation 310 in FIG. 3 can provide the packets into the MACFASTTXQ, the MACDATAQ, and the MACCEQ. By processing a service grant using an operation corresponding to operation 320 in FIG. 3, the modem can finalize MAC PDU based on the initial queues and any trimming or additional grabbing that needs to be done.

Once the MAC PDU is finalized, it can be provided to the MACSENDQ, using an operation such as operation 330 in FIG. 3. The previous contents of the MACSENDQ can be placed into a MACHARQQ using an operation such as operation 340 from FIG. 3. The contents of MACSENDQ can be provided to the physical layer for transmission.

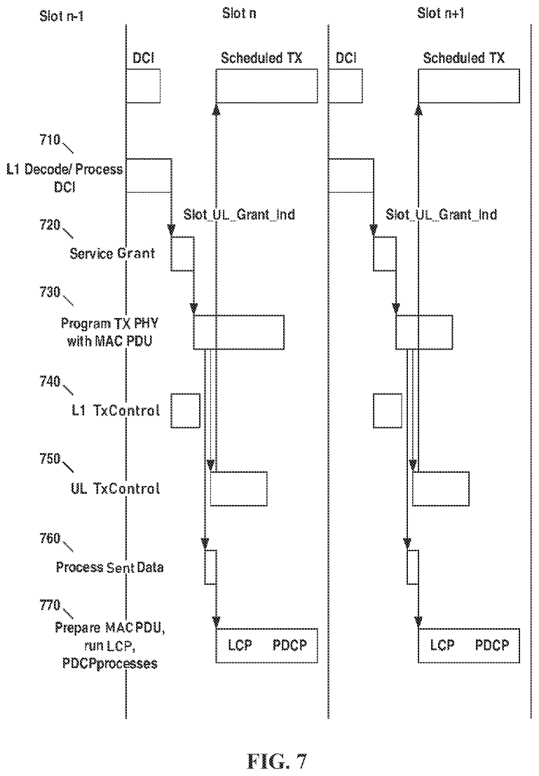

FIG. 7 illustrates a timing diagram in relation to a method such as shown in FIG. 3 according to certain embodiments of the present disclosure. As shown in FIG. 7, n can refer to a current slot, n+1 can refer to a next slot, and n−1 can refer to a last slot, and so on. With the timing, as shown in FIG. 7, it may be possible for a transmission timeline to be met even when the K2 offset indicates that the same slot n or next slot n+1 transmission is to occur upon reception of the grant from an access node.

As shown in FIG. 7, at operation 710 in response to DCI provided from an access node, the modem in a user equipment may begin the L1 decoding and processing of the downlink control information (DCI). This may be performed using L1 in the modem. At operation 720, service grant processing can occur based on a slot uplink grant indicator from the DCI. This processing can occur in the MAC layer. Then, at operation 730, the MAC layer can program transmission with MAC PDU. At operation 740, L1 can perform L1 transmission control, and at operation 750, the physical layer can perform UL transmission control. Operations 710, 720, 730, 740, and 750 may correspond to operation 330 in FIG. 3. Likewise, for example, operations 710 and 720 can correspond to operation 410 in FIG. 4. At operation 760, the MAC layer can process sent data. Operation 760 in FIG. 7 may correspond to operation 340 in FIG. 3. Then, at operation 770, the MAC layer can perform LCP processes and PDCP processes to prepare MAC PDU for the next transmission opportunity. Operation 770 may, for example, correspond to or include the pre-calculation operation 310 of FIG. 3.

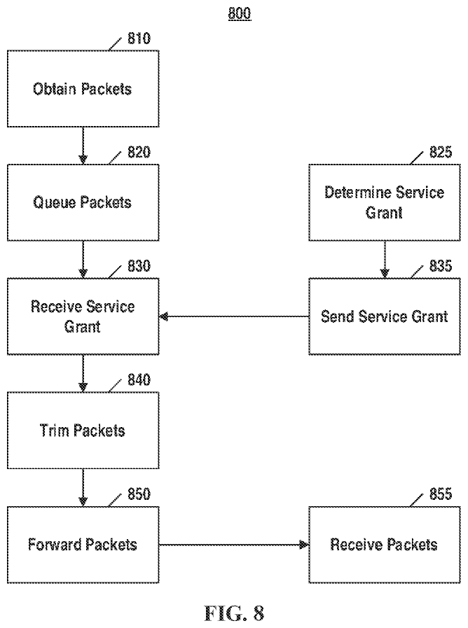

The approach of FIGS. 3-5 provide method flows as an illustration of certain aspects of the present disclosure. These embodiments are also illustrated in terms of data flow in FIG. 6 and in terms of timing in FIG. 7. FIGS. 8-10 provide another set of methods detailing various aspects of certain embodiments and may similarly correspond to FIGS. 6 and 7. The methods of FIGS. 8-10 may be viewed as complementary to the methods of FIGS. 3-5, such that the same modem may be practicing both methods by performing the data flow and timing shown in FIGS. 6 and 7.

FIG. 8 illustrates a method according to certain embodiments. It is understood that the operations shown in method 800 are not exhaustive and that other operations can be performed as well before, after, or between any of the illustrated operations. Further, some of the operations may be performed simultaneously, or in a different order than shown in FIG. 8.

As shown in FIG. 8, at operation 810, a plurality of packets to be transmitted via uplink are obtained, for example, by at least one processor of a modem (such as processor 1110 of node 1100 in FIG. 11, which may be user equipment 210 in FIG. 2). At operation 820, the plurality of packets are queued, for example, by the at least one processor, according to logical channel prioritization. Logical channel prioritization can refer to techniques for deciding which of various packet types should be served first. Generally speaking, control information may have a very high priority because it may be vital to continued operation. Likewise, packets associated with certain low-latency processes may also have high priority because they must be transmitted quickly to meet the quality of service (QoS) or other requirements. Other data packets may have other levels of priority. For example, certain applications may be given relative priority over other applications. Processes such as backing up log data may, for example, be given a very low priority. These and any other desired prioritization methods may be applied.

The queueing at operation 820 can include storing packets according to logical priority in contiguous memory. Thus, for example, the packets may be stored in consecutive bytes in memory in order from the highest priority packet to the lowest priority packet. The addresses of the lowest priority packets may be the last addresses in the memory span, and the addresses of the highest priority packets may be the first addresses in the memory span. As illustrated, for example, in FIG. 6, the signaling messages in MACDATAQ may be sorted according to logical priority. Thus, when constructing the MAC PDU, if the available space for MACDATAQ bytes in the MAC PDU is x bytes based on the service grant, the modem can read and/or use the first x bytes of the MACDATAQ portion of the prepared MAC PDU without having to process the remaining bytes, when the pre-assembled MAC PDU is too large. As shown in FIG. 6, the MAC CE packets can be provided at the end of the MAC PDU, even though they may be high priority packets. Nevertheless, within the section for MAC data bytes from MACDATAQ, the packets may be sorted by logical priority.

The queueing at operation 820 can include placing the plurality of packets partially into at least one high priority queue and partially into at least one low priority queue. For example, the high priority queue may include MACFASTTXQ and MACCEQ in FIG. 6, and low priority queue may include MACDATAQ in FIG. 6.

At operation 825, a service grant is determined by an access node, such as access node 220 in FIG. 2. The service grant can, at operation 835, be sent to a further device, such as user equipment 210 in FIG. 2.

As shown in FIG. 8, at operation 830, the service grant is received, for example, by at least one processor of the modem, after the queueing. At operation 840, the plurality of packets are trimmed, for example, by the at least one processor of the modem, according to the grant size of the service grant. The trimming at operation 840 can include removing an integer number of packets from the low priority queue, for example, from MACDATAQ in FIG. 6. The trimming at operation 840 can include modifying the packet data unit to exclude one or more packet of the plurality of packets. At operation 850, the remainder of the plurality of packets after the trimming is forwarded, for example, by the at least one processor, to transmission. These packets can be received at a further node at operation 855, such as access node 220 in FIG. 2.

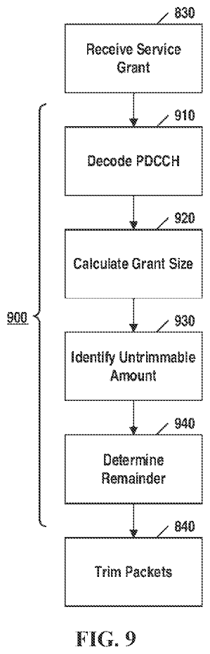

FIG. 9 illustrates further details of method 800 as shown in FIG. 8 according to certain embodiments. Method 900 of FIG. 9 may be an expansion of certain aspects of method 800, and consequently may be used together with method 800. As shown in FIG. 9, proceeding from receiving a service grant at operation 830, method 900 can include, at operation 910, decoding PDCCH. By decoding PCDDH, DCI information can be obtained. Next, at operation 920, method 900 can include calculating, by the at least one processor, the grant size based on the received service grant. Method 900 can also include, at operation 930, identifying, by the at least one processor, the size of an untrimmable subset of the plurality of packets, such as the amount in MACFASTTXQ and MACCEQ in FIG. 6. The trimming of the plurality of packets at operation 840 can include trimming the remainder of the plurality of packets excluding the untrimmable subset determined at operation 940. The trimming at operation 840 can be performed in a MAC layer. The packets can be MAC packet data units.

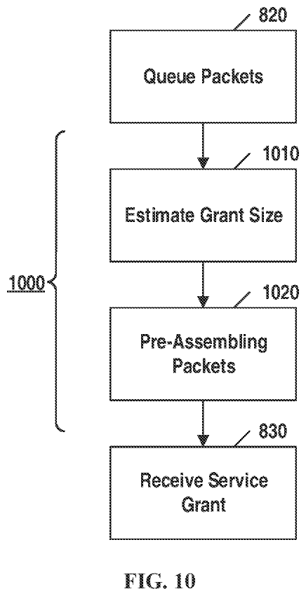

FIG. 10 illustrates further details of method 800 as shown in FIG. 8 according to certain embodiments. Method 1000 of FIG. 10 may be an expansion of certain aspects of method 800, and consequently may be used together with method 800. As shown in FIG. 10, after an initial queueing of packets at operation 820, method 1000 can include, at operation 1010, estimating, by the at least one processor, a predicted grant size prior to receiving the service grant. Method 1000 can also include, at operation 1020, pre-assembling, by the at least one processor, the plurality of packets into a packet data unit before receiving the service grant. At operation 830, after the pre-assembly has occurred, a service grant may be received.

FIG. 11 illustrates a device according to certain embodiments of the present disclosure. As shown in FIG. 11, a node 1100 can include various components. Node 1100 can correspond to user equipment 210, access node 220, or core network element 230 in FIG. 2. In some embodiments, node 1100 corresponds to the modem in user equipment 210, access node 220, or core network element 230 in FIG. 2.

As shown in FIG. 11, node 1100 can include a processor 1110, a memory 1120, and a transceiver 1130. These components are shown as connected to one another by a bus, but other connection types are also permitted. Transceiver 1130 may include any suitable device for sending and/or receiving data. Node 1100 may include one or many transceivers, although only one transceiver 1130 is shown for simplicity of illustration. An antenna 1140 is shown as a possible communication mechanism for node 1100. Multiple antennas and/or arrays of antennas may be utilized. Additionally, examples of node 1100 may communicate using wired techniques rather than (or in addition to) wireless techniques. For example, access node 220 may communicate wirelessly to user equipment 210 and may communicate by a wired connection (for example, by optical or coaxial cable) to core network element 230. Other communication hardware, such as a network interface card (NIC), can be included.

When node 1100 is a user equipment, additional components may also be included, such as a user interface (UI), sensors, and the like. Similarly, node 1100 may be implemented as a blade in a server system when node 1100 is configured as a core network element 230. Other implementations are also possible.

As shown in FIG. 11, node 1100 may include processor 1110. Although only one processor is shown, it is understood that multiple processors can be included. Processor 1110 may be any suitable computational device, such as a central processing unit (CPU), a microcontroller unit (MCU), application-specific integrated circuit (ASIC), field-programmable gate array (FPGA), or the like. Processor 1110 may be a hardware device having one or many processing cores. In some embodiments in which node 1100 corresponds to a modem, processor 1110 may be a baseband processor.

As shown in FIG. 11, node 1100 may also include memory 1120. Although only memory is shown, it is understood that multiple memories can be included. Memory 1120 can broadly include both memory and storage. For example, memory 1120 can include random access memory (RAM) included on the same chip with processor 1110. Memory 1120 can also include storage, such as a hard disk drive (HDD), solid-state drive (SSD), or the like. Other memory types and storage types are also permitted.

Similarly, node 1100 can also be configured as personal computer 250, router 260, tablet 270, database 280, or authentication server 290 in FIG. 2. Node 1100 can be configured to perform any of the above-described methods using hardware alone or hardware operating together with software.

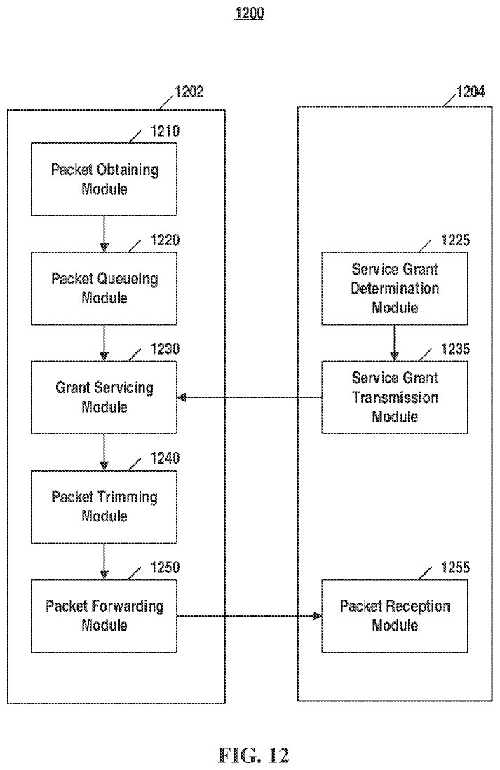

FIG. 12 illustrates a block diagram of an exemplary system 1200 for data transmission scheduling according to certain embodiments of the present disclosure. As shown in FIG. 12, system 1200 can include a user equipment 1202 and an access node 1204, each of which can be implemented by node 1100 described above with respect to FIG. 11. User equipment 1202 and access node 1204 may be examples of user equipment 210 and access node 220, respectively, in the system of FIG. 2.

User equipment 1202 can include a packet obtain module 1210 configured to obtain a plurality of packets to be transmitted via uplink. User equipment 1202 can also include a packet queueing module 1220 configured to queue the plurality of packets according to logical channel prioritization. The queueing by packet queueing module 1220 can include storing packets according to logical priority in contiguous memory. The queueing by packet queueing module 1220 can include placing the plurality of packets partially into at least one high priority queue and partially into at least one lower priority queue. For example, the high priority queue may include MACFASTTXQ and MACCEQ in FIG. 6, and low priority queue may include MACDATAQ in FIG. 6.

Access node 1204 can include a service grant determination module 1225 configured to determine a service grant and a service grant transmission module 1235 configured to send the service grant to user equipment 1202.

As shown in FIG. 12, user equipment 1202 can further include a grant serving module 1230 configured to receive and process the service grant received from access node 1204 after queueing the packets by packet queueing module 1220. User equipment 1202 can further include a packet trimming module 1240 configured to trim the plurality of packets according to a grant size of the service grant. The trimming by packet trimming module 1240 can include removing an integer number of packets from the low priority queue, for example, from MACDATAQ in FIG. 6. The trimming by packet trimming module 1240 can include modifying the packet data unit to exclude one or more packet of the plurality of packets.

User equipment 1202 can additionally include packet forwarding module 1250 configured to forward the remainder of the plurality of packets to transmission after trimming the packets by packet trimming module 1240. These packets can be received at a packet reception module 1255 of access node 1204.

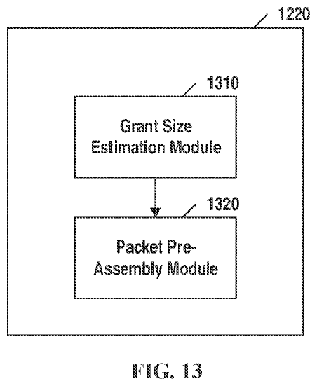

FIG. 13 illustrates a block diagram of an exemplary packet queueing module 1220 of system 1200 shown in FIG. 12 according to certain embodiments of the present disclosure. As shown in FIG. 13, packet queueing module 1220 may include a grant size estimation module 1310 configured to estimate the predicted grant size prior to receiving the service grant. Packet queueing module 1220 can also include packet pre-assembly module 1320 configured to pre-assemble the plurality of packets into a packet data unit before receiving the service grant.

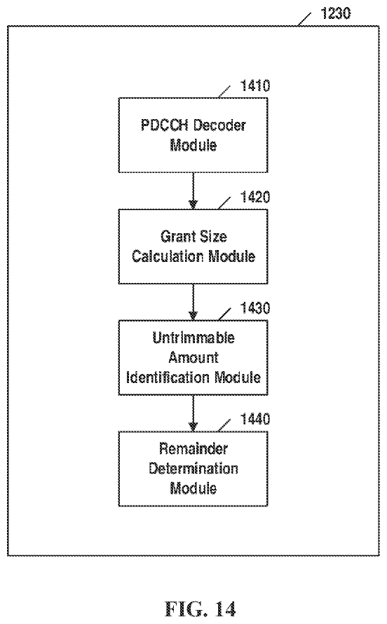

FIG. 14 illustrates a block diagram of an exemplary grant serving module 1230 of system 1200 shown in FIG. 12 according to certain embodiments of the present disclosure. As shown in FIG. 14, grant serving module 1230 can include a PDCCH decoder module 1410 configured to decode PDCCH. By decoding PCDDH, DCI information can be obtained, which can be used for calculating the grant size. Grant serving module 1230 can also include a grant size calculation module 1420 configured to calculate the grant size based on the received service grant. Grant serving module 1230 can also include an untrimmable amount identification module 1430 configured to identify the size of an untrimmable subset of the plurality of packets, such as the amount in MACFASTTXQ and MACCEQ in FIG. 6. Grant serving module 1230 can additionally include a remainder determination module 1440 configured to determine a remainder of the plurality of packets excluding the untrimmable subset.

The modules of FIGS. 12-14 can be variously implemented in hardware alone or hardware running software, such as computer-program instructions being stored in a memory and being run on a hardware processor. FIG. 11 provides a possible device for implementing such modules. Various modules can be combined or re-arranged. The above-illustrated examples are just illustrative and not limiting.

Another aspect of the disclosure is directed to a non-transitory computer-readable medium encoded with instructions that, when executed by at least one processor (e.g., processor 1110 in FIG. 11), perform any processes disclosed herein. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc, a flash drive, or a solid-state drive having the computer instructions stored thereon.

Certain embodiments of the present disclosure may have various benefits and/or advantages. For example, certain embodiments of the present disclosure may be able to meet a transmission timeline even when the K2 offset requires the same slot or next slot transmission from when the grant is received. Furthermore, certain embodiments of the present disclosure may provide lower latency in preparing MAC PDU packets from L3, L2 to the MAC and physical layers for transmission. Certain embodiments of the present disclosure may also provide minimal data movement for end-to-end data transfer from L3 to the physical layer. Additionally, certain embodiments of the present disclosure may use less on-chip or external memory because the MAC PDU may be directly prepared without intermediate steps for buffering L2 data queues.

Furthermore, certain embodiments of the present disclosure may reduce power for the entire chipset due to reduced memory and data movement. Moreover, certain embodiments of the present disclosure may also be applicable to a fixed grant allocation scheme as well, for example, in cases where dynamic and fixed grant allocations are concurrently applied. Additionally, certain embodiments of the present disclosure may be applicable for different wireless technologies requiring uplink grant access by the base station, such as 5G, LTE, or future 3GPP or other standards.

According to one aspect of the present disclosure, an apparatus can include at least one processor and at least one memory including computer program code. The at least one memory and the computer program code can be configured to, with the at least one processor, cause the apparatus at least to obtain a plurality of packets to be transmitted via uplink. The at least one memory and the computer program code can also be configured to, with the at least one processor, cause the apparatus at least to queue the plurality of packets according to logical channel prioritization. The at least one memory and the computer program code can further be configured to, with the at least one processor, cause the apparatus at least to receive a service grant after the queueing. The at least one memory and the computer program code can additionally be configured to, with the at least one processor, cause the apparatus at least to trim the plurality of packets according to a grant size of the service grant.

In some embodiments, the at least one memory and the computer program code can be further configured to, with the at least one processor, cause the apparatus at least to forward a remainder of the plurality of packets after the trimming to transmission.

In some embodiments, the at least one memory and the computer program code can be configured to, with the at least one processor, cause the apparatus at least to queue the plurality of packets at least by placing the plurality of packets partially into at least one high priority queue and partially into at least one low priority queue.

In some embodiments, the at least one memory and the computer program code can be configured to, with the at least one processor, cause the apparatus at least to trim the plurality of packets at least by removing an integer number of packets from the low priority queue.

In some embodiments, the at least one memory and the computer program code can be further configured to, with the at least one processor, cause the apparatus at least to calculate the grant size based on the received service grant. The at least one memory and the computer program code can also be configured to, with the at least one processor, cause the apparatus at least to identify a size of an untrimmable subset of the plurality of packets. The trimming the plurality of packets can include trimming a remainder of the plurality of packets excluding the untrimmable subset.

In some embodiments, the at least one memory and the computer program code can be configured to, with the at least one processor, cause the apparatus at least to trim the plurality of packets in a MAC layer. The packets can include MAC packet data units.

In some embodiments, the at least one memory and the computer program code can be further configured to, with the at least one processor, cause the apparatus at least to estimate a predicted grant size prior to receiving the service grant. The at least one memory and the computer program code can also be configured to, with the at least one processor, cause the apparatus at least to pre-assemble the plurality of packets into a packet data unit before receiving the service grant.

In some embodiments, the at least one memory and the computer program code can be configured to, with the at least one processor, cause the apparatus at least to trim the plurality of packets at least by modifying the packet data unit to exclude one or more packets of the plurality of packets.

In some embodiments, the at least one memory and the computer program code can be configured to, with the at least one processor, cause the apparatus at least to queue the plurality of packets at least by storing the plurality of packets according to logical priority in contiguous memory.

According to another aspect of the present disclosure, a method for data transmission scheduling can include obtaining, by at least one processor, a plurality of packets to be transmitted via uplink. The method can also include queueing, by the at least one processor, the plurality of packets according to logical channel prioritization. The method can further include receiving, by the at least one processor, a service grant after the queueing. The method can additionally include trimming, by the at least one processor, the plurality of packets according to a grant size of the service grant.

In some embodiments, the method can also include forwarding, by the at least one processor, a remainder of the plurality of packets after the trimming to transmission.

In some embodiment, the queueing can include placing the plurality of packets partially into at least one high priority queue and partially into at least one low priority queue.

In some embodiments, the trimming can include removing an integer number of packets from the low priority queue.

In some embodiments, the method can include calculating, by the at least one processor, a grant size based on the received service grant. The method can also include identifying, by the at least one processor, a size of an untrimmable subset of the plurality of packets. The trimming the plurality of packets can include trimming a remainder of the plurality of packets excluding the untrimmable subset.

In some embodiments, the trimming can be performed in a MAC layer. The packets may be MAC packet data units.

In some embodiments, the method can include estimating, by the at least one processor, a predicted grant size prior to receiving the service grant. The method can also include pre-assembling, by the at least one processor, the plurality of packets into a packet data unit before receiving the service grant.

In some embodiments, the trimming can include modifying the packet data unit to exclude one or more packets of the plurality of packets.

In some embodiments, the queueing can include storing the plurality of packets according to logical priority in contiguous memory.

According to still another aspect of the present disclosure, a non-transitory computer-readable medium can be encoded with instructions that, when executed at least one processor, perform a process. The process can include obtaining a plurality of packets to be transmitted via uplink. The process can also include queueing the plurality of packets according to logical channel prioritization. The process can further include receiving a service grant after the queueing. The process can additionally include trimming the plurality of packets according to a grant size of the service grant.

In some embodiments, the process can include forwarding a remainder of the plurality of packets after the trimming to transmission.

In some embodiments, the queueing can include placing the plurality of packets partially into at least one high priority queue and partially into at least one low priority queue.

In some embodiments, the trimming can include removing an integer number of packets from the low priority queue.

In some embodiments, the process can include calculating a grant size based on the received service grant. The process can further include identifying a size of an untrimmable subset of the plurality of packets. The trimming the plurality of packets can include trimming a remainder of the plurality of packets excluding the untrimmable subset.

In some embodiments, the trimming can be performed in a MAC layer. The packets can be MAC packet data units.

In some embodiments, the process can include estimating a predicted grant size prior to receiving the service grant. The process can also include pre-assembling the plurality of packets into a packet data unit before receiving the service grant.

In some embodiments, the trimming can include modifying the packet data unit to exclude one or more packets of the plurality of packets.

In some embodiments, the queueing can include storing the plurality of packets according to logical priority in contiguous memory.

According to yet another aspect of the disclosure, an apparatus can include a packet obtaining module configured to obtain a plurality of packets to be transmitted via uplink. The apparatus can also include a packet queueing module configured to queue the plurality of packets according to logical channel prioritization. The apparatus can further include a grant serving module configured to receive a service grant after the queueing. The apparatus can additionally include a packet trimming module configured to trim the plurality of packets according to a grant size of the received service grant.

In some embodiments, the apparatus can further include a packet forwarding module configured to forward a remainder of the plurality of packets after the trimming to transmission.

In some embodiments, the packet trimming module can be further configured to place the plurality of packets partially into at least one high priority queue and partially into at least one low priority queue.

In some embodiments, the packet trimming module can be further configured to remove an integer number of packets from the low priority queue.

In some embodiments, the grant serving module can include a grant size calculation module configured to calculate a grant size based on the received service grant. The grant serving module can include a untrimmable amount identification module configured to identify a size of an untrimmable subset of the plurality of packets. The packet trimming module can be further configured to trim a remainder of the plurality of packets excluding the untrimmable subset.

In some embodiments, the trimming can be performed in a MAC layer. The packets can include MAC packet data units.

In some embodiments, the packet queueing module can include a grant size estimation module configured to estimate a predicted grant size prior to receiving the service grant. The packet queueing module can include a packet pre-assembly module configured to pre-assemble the plurality of packets into a packet data unit before receiving the service grant.

In some embodiments, the packet trimming module can be further configured to modify the packet data unit to exclude one or more packets of the plurality of packets.

In some embodiments, the packet queueing module can be further configured to store the plurality of packets according to logical priority in contiguous memory.

The foregoing description of the specific embodiments will so reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The particular arrangements provided are illustrative and without limitation. Accordingly, the functional blocks, modules, and steps may be re-ordered or combined in different ways than in the examples provided above. Likewise, certain embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. An apparatus, comprising:
at least one processor; and
at least one memory including computer program code,
wherein the at least one memory and the computer program code are configured to, with the at least one processor, cause the apparatus at least to:
obtain a plurality of packets to be transmitted via uplink;
queue the plurality of packets according to logical channel prioritization;
receive a service grant after the queueing; and
trim the plurality of packets according to a grant size of the received service grant.

2. The apparatus of claim 1, wherein the at least one memory and the computer program code are further configured to, with the at least one processor, cause the apparatus at least to forward a remainder of the plurality of packets after the trimming to transmission.

3. The apparatus of claim 1, wherein the at least one memory and the computer program code are configured to, with the at least one processor, cause the apparatus at least to queue the plurality of packets at least by placing the plurality of packets partially into at least one high priority queue and partially into at least one low priority queue.

4. The apparatus of claim 3, wherein the at least one memory and the computer program code are configured to, with the at least one processor, cause the apparatus at least to trim the plurality of packets at least by removing an integer number of packets from the low priority queue.

5. The apparatus of claim 1, wherein the at least one memory and the computer program code are further configured to, with the at least one processor, cause the apparatus at least to:
calculate the grant size based on the received service grant; and
identify a size of an untrimmable subset of the plurality of packets,
wherein the trimming the plurality of packets comprises trimming a remainder of the plurality of packets excluding the untrimmable subset.

6. The apparatus of claim 1, wherein the at least one memory and the computer program code are configured to, with the at least one processor, cause the apparatus at least to trim the plurality of packets in a medium access control (MAC) layer, wherein the plurality of packets comprise MAC packet data units.

7. The apparatus of claim 1, wherein the at least one memory and the computer program code are further configured to, with the at least one processor, cause the apparatus at least to:
estimate a predicted grant size prior to receiving the service grant; and
pre-assemble the plurality of packets into a packet data unit before receiving the service grant.

8. The apparatus of claim 7, wherein the at least one memory and the computer program code are configured to, with the at least one processor, cause the apparatus at least to trim the plurality of packets at least by modifying the packet data unit to exclude one or more packets of the plurality of packets.

9. The apparatus of claim 1, wherein the at least one memory and the computer program code are configured to, with the at least one processor, cause the apparatus at least to queue the plurality of packets at least by storing the plurality of packets according to logical priority in contiguous memory.

10. A method for data transmission scheduling, comprising:
obtaining, by at least one processor, a plurality of packets to be transmitted via uplink;
queueing, by the at least one processor, the plurality of packets according to logical channel prioritization;
receiving, by the at least one processor, a service grant after the queueing; and
trimming, by the at least one processor, the plurality of packets according to a grant size of the received service grant.

11. The method of claim 10, further comprising forwarding, by the at least one processor, a remainder of the plurality of packets after the trimming to transmission.

12. The method of claim 10, wherein the queueing comprises placing the plurality of packets partially into at least one high priority queue and partially into at least one low priority queue.

13. The method of claim 12, wherein the trimming comprises removing an integer number of packets from the low priority queue.

14. The method of claim 10, further comprising:
calculating, by the at least one processor, a grant size based on the received service grant; and
identifying, by the at least one processor, a size of an untrimmable subset of the plurality of packets,
wherein the trimming the plurality of packets comprises trimming a remainder of the plurality of packets excluding the untrimmable subset.

15. The method of claim 10, wherein the trimming is performed in a medium access control (MAC) layer, and the plurality of packets comprise MAC packet data units.

16. The method of claim 10, further comprising:
estimating, by the at least one processor, a predicted grant size prior to receiving the service grant; and
pre-assembling, by the at least one processor, the plurality of packets into a packet data unit before receiving the service grant.

17. The method of claim 16, wherein the trimming comprises modifying the packet data unit to exclude one or more packets of the plurality of packets.

18. The method of claim 10, wherein the queueing comprises storing the plurality of packets according to logical priority in contiguous memory.

19. A non-transitory computer-readable medium encoded with instructions that, when executed by at least one processor, perform a process comprising:
obtaining a plurality of packets to be transmitted via uplink;
queueing the plurality of packets according to logical channel prioritization;
receiving a service grant after the queueing; and
trimming the plurality of packets according to a grant size of the received service grant.

20. The computer-readable medium of claim 19, wherein the process further comprises forwarding a remainder of the plurality of packets after the trimming to transmission.
